(19) United States
(12) Patent Application Publication
(10) Pub. No.: US 2015/0301169 A1
(43) Pub. Date: Oct. 22, 2015

(54) A METHOD AND A DEVICE FOR DETERMINING THE TRAJECTORY OF A BULLET EMITTED BY A SHOTGUN AND FOR LOCATING A SHOT POSITION

(71) Applicant: I.D.S. - INGEGNERIA DEI SISTEMI S.P.A., Pisa (IT)

(72) Inventors: Gaetano DE PASQUALE, San Giuliano Terme (IT); Lorenzo BENVENUTI, Pisa (IT); Fabio CARNEVALE, Colleferro (IT); Marina MARRA, San Giuliano Terme (IT)

(21) Appl. No.: 14/440,723

(22) PCT Filed: Nov. 5, 2013
(86) PCT No.: PCT/IB2013/059921

§ 371 Date: May 5, 2015

(30) Foreign Application Priority Data
Nov. 5, 2012 (IT) PI2012A000110

(51) Int. Cl. G01S 13/42; G01S 13/88

(52) U.S. Cl. CPC G01S 13/426; G01S 13/88

(57) ABSTRACT

A radar device and a method for determining, in an observation zone, the trajectory of a bullet fired by a small firearm, wherein the radar device is arranged at a radar site and performs a radar scanning step of the observation zone. The radar-scanning step comprises emitting a periodic radar signal of frequency set between 4 GHz and 18 GHz, in particular, a signal comprising two tones that have respective distinct frequencies, and demodulating and processing a return signal received in response to the radar signal, detecting, when a shot is fired, a trace of the bullet comprising a plurality of points or plots.

### FIELD OF THE INVENTION

The present invention relates to a method and to a device for determining the trajectory of a bullet, shot by a small firearm after a low-arched or direct shot (small arm weapon) and travelling at a supersonic or subsonic speed, indicating the direction from which the bullet is coming.

The invention enables protection actions and/or response reactions by an operator in real time after the shot.

In particular, the invention relates to a method and to a device for localizing the position from which the bullet has been shot.

### BACKGROUND OF THE INVENTION

### Technical Problems

For decades, army and police forces have been more and more frequently facing asymmetric warfare situations. In particular, operations in urban places, where snipers and/or occasional fighters are hidden, are quite recurrent.

Such fighters have normally inferior technology, but in the combat scenario they can conceal in more advantageous positions than the regular forces. In fact, they can easily dissimulate in the crowd, shoot from hiding places or from normal vehicles, and then disappear in the traffic or in the crowd. This makes it difficult distinguishing the fighters from the civilians, in such a way that regular forces can be vulnerable to sniper shots from hidden and/or unattended locations.

For this reason, it is always more difficult and risky to carry out recognition missions in adverse territories even on armoured/armed vehicles, missions of defence of the territory and of military bases, of airports, of movable posts such as checkpoints and other structures, missions of protection of persons in an unpredictably adverse environment, missions of protection of military convoys or of humanitarian aids delivery means.

Therefore, the need is felt of systems for increasing the protection of such objects against shooters such as snipers, guerrilla fighters and occasional fighters.

Devices are known for localizing snipers that comprise acoustic sensors. Their performances strongly depend on sniper's camouflage. For instance, the acoustic devices are not much effective for localizing a bullet fired through a hole of a wall of a reconstructing. Furthermore, the acoustic devices are influenced by particular and temporary conditions like echoes caused by the structures of the urban environments, for example by buildings.

It is also known that the acoustic sensors are substantially unable to localize bullets travelling at a subsonic speed as in the case of shots from RPG (Reaktivnyj Protivotankovyj Granatomët, reaction anti-tank grenade launcher), or by silencer-equipped weapons.

Radar systems are also known for measuring and tracing indirect shots like those fired by mortars. Such radar systems do not allow tracing too close and small objects, i.e. objects having size of about 1 cm, and/or objects having an RCS (Radar Cross Section) reflectivity less than 1 cm². Furthermore, such radar systems are capable of localizing a target only outside of a blind zone about the device itself. The amplitude of the blind zone depends on the duration of the pulses of the radar signal, and is typically about one hundred metres.

In summary,
the acoustic devices are unable to detect subsonic shots such as silenced shots. In supersonic cases, they are able to localize the shooter position, but they can determine the bullet direction less precisely than the radar systems;
the radar systems for detecting mortar shots are not able to localize small objects having an RCS lower than 1 cm², and do not work within a short distance.

Allen et al. describe a method for determining the direction of a bullet by a radar system comprising three radar devices arranged in predetermined positions, where each radar emits a continuous-wave (CW) radar signal for carrying out a Doppler measurement on a bullet. The Doppler measurement data are used to determine bullet parameters such as the miss-distance, i.e. the minimum distance from the respective radar at which the object passes through, the speed of the bullet and the instant when the bullet passes through the miss-distance. The speed can be used for localizing the shooter position. Through a process of fusing the data obtained by the three radar devices, i.e. through a triangulation process, it is possible to estimate the points of the bullet trajectory.

DE 2011 012 620 B3 describes a method for determining the trajectory of bullets comprising an electronic scan interferometric radar apparatus performing a succession of detections of the bullet in successive instants from a single radar site, and where each detection provides the radial speed of the bullet and an azimuth angle of the bullet with respect to the radar apparatus. The position of the points is calculated indirectly, evaluating at first the so-called “miss distance” (or POCA) of the bullet trajectory, and then the trajectory. Both these systems carry out an estimation of the position of the points indirectly, by measurements that limit the precision of such estimate.

### SUMMARY OF THE INVENTION

It is therefore a feature of the invention to provide a method and a device for detecting small size bullets in direct shots that travel at a subsonic or supersonic speed, in a time and with a precision in which a real time protection and/or response actions are permitted.

It is also a feature of the invention to provide a method and a device for determining the trajectory of bullets, in particular, of bullets shot by small guns or by subsonic weapons like RPG.

It is then a particular feature of the invention to provide a method and a device for localizing a shooter position, even if it is located outside of the observation zone of the radar.

It is a further feature of the invention to provide a method and a device for localizing a bullet in a zone close to an observation point.

These and other objects are achieved by a method for determining a trajectory of a bullet shot by a firearm, the method comprising the steps of:
defining an observation zone;
defining a radar site;
arranging an electronic-scan radar device at the radar site;
scanning the observation zone by the radar device, wherein the step of scanning comprises the steps of:
   emitting a radar signal comprising a periodic waveform that has a frequency set between 4 GHz and 18 GHz;
   receiving and demodulating a return signal back from the observation zone in response to said radar signal;
      wherein the step of scanning also comprises a step of:
   processing the return signal and reconstructing a trajectory of the bullet,
      wherein the radar-scanning step has a coherent integration time (TIC), for a predetermined signal wavelength λ, set between 10λ^{1/2} and 40λ^{1/2}, wherein the wavelength λ is expressed in metres and the coherent integration time is expressed in milliseconds,
      wherein the step of processing the return signal comprises a step of sampling the return signal at a sampling rate (f_{c}) higher than a predetermined lower limit value f_{c,min} depending on the frequency (v) of the radar signal,
      said step of reconstructing comprising, for each revealed bullet, the steps of directly measuring points, i.e. plots, of a radar trace of the bullet, the steps of measuring comprising, for each of the plots:
measuring a range of the bullet, i.e. a distance of the bullet from the radar site;
measuring an azimuth angle of the bullet with respect to the radar site,
   and wherein a step is provided of computing, starting from the trace, a line passing proximate to the plots, wherein the line is assumed as the trajectory of the bullet.

This way, an advantageous trade-off is obtained between the signal detection capacity, in terms of signal/noise ratio, and the signal Doppler filtering. In fact, as well known in the radar technique, at each time TIC a Doppler analysis is carried out on the return signal, in order to detect travelling bullets. The TIC value according to the invention depends upon the very low size and RCS of the target, with respect to conventional radar targets. In fact, radar targets normally have an RCS larger than 10 m², which is a value more than 10⁶ times higher than 0.1 cm². This way:
the signal-to-noise ratio is set to a maximum value;
the estimation precision of the bullet trajectory parameters is optimized.

By choosing a sampling rate value and a coherent integration time as indicated above, an extension of the radar technique is possible to the detection of objects much smaller than the conventional targets, i.e. to the detection of objects having a size of about one centimetre, in particular to the detection of bullets shot by direct fire weapons. Moreover, the detection it is possible for bullets of this size that travel both at a supersonic and a subsonic speed.

A further advantage of the invention is that it makes it possible to localize a bullet close to the observation point. Besides the case of a bullet, the invention is surprisingly capable of detecting even indirectly fired bullets, like in the case of a mortar shot, in the last phase of their trajectory, before they fall to the ground. In fact, the trajectory can be precisely determined, in order to possibly take countermeasures or to calculate the shooter position precisely enough. In order to carry out such a measurement, the elevation angle has only to be added to the measured plot.

In particular, the lower limit value f_{c,min} of the sampling rate f_{c} is 54 kHz at a signal frequency of 4 GHz, and is 240 kHz at a signal frequency of 18 GHz, and the lower limit value is expressed by the formula:

f_{c,min}=(40/3)v,

wherein v is the signal frequency expressed in GHz, and f_{c,min} is expressed in kHz.

In an exemplary embodiment, the step of emitting the radar signal is carried out permanently during the step of scanning. In particular, the radar signal is a continuous-wave radar signal CW. A continuous-wave radar signal, modulated or not, makes tit possible to see a target at a distance as short as a few metres or a few tenths of metres, which is required for an effective detection of a direct shot.

In particular, the continuous-wave radar signal comprises two waveforms that have respective distinct frequencies. Such a radar signal allows directly measuring the range of the bullet at a point of the trace, according to a process described hereinafter, as an example. In particular, the radar signal comprises two continuous sinusoidal tones.

In an exemplary embodiment, the radar signal comprises a continuous non-modulated waveform (CW). As an alternative, the radar signal comprises a frequency-modulated continuous waveform, in particular, a linearly modulated continuous waveform (LFMCW). This way, as described hereinafter, the range can be determined even before a threshold-detection step of the point, i.e. of the point, i.e. of the plot.

The sampling rate value, which is higher than a given lower limit value that depends on the signal frequency, and which is selected as specified above, makes it possible to determine the position, in particular it makes it possible to directly measure the range of high-speed moving objects, in particular of supersonic moving objects.

The TIC value, which is practically a time during which the target is observed, and which is selected as indicated above, causes the radar sensitivity to increase, and allows detecting small objects, in particular, it allows directly measuring their range. More in detail, such a coherent integration time makes it possible to detect objects that have a low RCS value, typically a reflectivity value lower than 1 cm², down to a very low minimum value of about 0.1 cm².

In particular, the coherent integration time, for a given wavelength λ of the signal, is set between 20λ½and 35λ½ more in particular, it is set between 22λ½and 32λ½.

In particular, in the observation zone a plurality of observation sectors is defined that have a common vertex at the radar site, and the step of computing the line as the trace of the bullet comprises a step of fusing traces the have been previously detected in the sectors of the observation zone, which are distinct from one another. The whole azimuth angle can be scanned by this electronic scan technique, in which a 360° azimuth scanning is obtained by electronically scanning a circular array of antennas, each of which covers one specific sector, while overcoming the speed restrictions of the mechanical rotation devices of the conventional radar systems.

The step of computing a line can be carried out using an algorithm for computing a motion equation, i.e. a motion law of the bullet, starting from the plot data.

In particular, a step is provided of backtracking and localizing a shooter position at a point of the trajectory. In the case of a direct shot, the shooter position may be some hundreds of metres far from the position of the device, at most it may be at a distance of about one kilometre. Unlike the prior art methods, by the method of the invention, which is based on using a radar sensor, the place where shot was fired is not localized directly, but it is localized starting from the trajectory of the flying bullet. This makes it possible to localize position that have been masked by a masking technique and/or by environment conditions favourable to the snipers, such as particular lighting and/or noise conditions.

Advantageously, a step is provided of prearranging an acoustic sensor at the radar site, the acoustic sensor being configured for detecting a compression wave, i.e. a “muzzle blast”, caused by the shot and travelling towards the radar site, and the step of localizing the shooter position is discontinued as soon as the compression wave is detected by the acoustic sensor. This mates it possible to stop the backtracking, i.e. the step of reconstructing the trajectory of the bullet, even outside the observation zone, as soon as the acoustic sensor detects the incoming compression wave created by the shot. This way, the shooter position can be localized more precisely. This optional feature selection is particularly advantageous for bullets travelling at a supersonic speed.

In another exemplary embodiment, the radar signal is a range-gated signal, i.e. a signal in which the step of emitting the radar signal and the step of receiving the return signals, i.e. the echo provided by the targets that are present in the observation zone, are carried out in time-division with respect to each other, i.e. during distinct time intervals, which causes an attenuation of the return signals back from the observation zone. The duration of each step is predetermined, and is carried out according to a period, corresponding to a repetition frequency, that is much longer than the coherent integration time (TIC), wherein the cadence and the duration are selected so that the signal/noise ratio is the best possible at the maximum detection distance of the bullets. This causes a sensitivity decrease of the radar device at close ranges, i.e. at a small distance from itself. This makes it possible to reduce or substantially eliminate the noise due to electrostatic discharges at a short-very short distance. In fact, a radar system conceived for short distance detection, such as the system according to the invention, is conceived for being very sensitive. For this reason, this system is also particularly sensitive towards short-distance noise. This short distance noise can be caused by electrostatic discharges due to rain drops falling to the ground, or to electrostatically charged objects coming into contact with each other. The short distance noise can reduce the radar device sensitivity down to an extent of a few tenths of dB.

In particular, a third time interval, during which only the reception means of the antenna are working, is complementary to the first interval with respect to the whole interval, and the reception units of the antenna are turned on substantially immediately after turning off the emission means of the antenna unit.

As an alternative, a step is provided of waiting a separation time interval before turning on the reception means of the antenna unit, during which both the emission means and the reception means are inactive. In particular, the separation time interval lasts between 10 and 30 nanoseconds, more in particular, about 20 nanoseconds. This further reduces the local noise besides preventing an unwanted coupling between the emission and the reception means.

In a particular exemplary embodiment, the step of processing comprises determining the radial speed of the bullet, as a further item of the plot. The radial speed can be used for assisting the determination of the range, in order to improve the precision.

In a particular exemplary embodiment, the step of processing comprises, for each point, a step of determining an elevation angle of the bullet.

The above mentioned objects are also reached by an electronic-scan radar device for determining, from a radar site, a trajectory of a bullet shot from an unknown shooter position, the bullet crossing an observation zone arranged to be observed by the radar device, the radar device comprising:
a radar scan means for carrying out a radar-scanning of the observation zone, comprising:
   an emission means, configured for emitting a radar signal comprising a periodic waveform having a frequency (v) set between 4 GHz and 18 GHz;
   a reception and demodulation means for demodulating a return signal back from the observation zone in response to the radar signal;
      wherein the radar scan means comprises
a signal processing means for processing the return signal and a detection means for reconstructing a radar trace of the bullet,
   wherein the signal processing means and the detection means are configured for operating at a coherent integration time (TIC), wherein, for a predetermined wavelength λ of the radar signal, the coherent integration time is set between 10λ½ and 40λ½, where the wavelength λ is expressed in metres and the coherent integration time is expressed in milliseconds,
   wherein the signal processing means has a sampling rate (f_{c}) of the return signal higher than a predetermined lower limit value f_{c,min} depending on the frequency (v) of the radar signal,
   wherein the signal processing means is configured for carrying out a direct measurement of parameters of each of the points, comprising:
measuring a range of the bullet, i.e. a distance of the bullet from the radar site,
measuring an azimuth angle of the bullet with respect to the radar site,
   and wherein the signal processing means is configured to calculate, starting from the trace, a line that passes proximate to the plots, so that the line is assumed as the trajectory of the bullet.

In an exemplary embodiment, the signal processing means is configured for reconstructing, starting from the trace, a line that passes proximate to the points, so that this line can be assumed as the trajectory of the bullet.

In particular, the signal processing means is configured for carrying out a step of backtracking and localizing a shooter position at a point of the trajectory.

In particular, the signal processing means and the detection means is configured for operating at a coherent integration time set between 20λ^{1/2} and 35λ^{1/2}, more in particular, set between 22λ^{1/2} and 32λ^{1/2}, for a determined wavelength λ of said signal.

In particular, the emission means is configured for permanently emitting the radar signal during a radar-scanning. In this case, the emission means can be configured for emitting a non-modulated continuous-wave signal (CW), or a linearly frequency-modulated continuous waveform (LFMCW).

As an alternative, the emission means is configured for emitting a range-gated signal, i.e. it is configured for emitting the radar signal during a predetermined emission time interval and with a cadence longer than the duration, where the cadence and the duration are selected in such a way that an observation zone is created that is centred at the radar site and that is defined by a predetermined maximum observation distance, the attenuation of the received power having a minimum value at the maximum observation distance.

In an exemplary embodiment, said device comprises an acoustic sensor configured for detecting a compression wave caused by the shot and travelling towards the radar site, wherein the radar device is configured for blocking the step of localizing said shooter position as soon as the compression wave is detected by the acoustic sensor.

### BRIEF DESCRIPTION OF THE DRAWINGS

The invention will be now shown with the following description of its exemplary embodiments, exemplifying but not limitative, with reference to the attached drawings in which:

FIG. 1 is a block diagram that describes the operation of a radar unit configured for operating with the method according to the invention;

FIGS. 2 and 3 diagrammatically show two radar systems comprising a single transceiver and two transceivers, respectively, for determining the trajectory of a bullet, according to the invention, in an observation zone comprising four observation sectors;

FIG. 4 shows a block diagram of a device according to an exemplary embodiment of the invention;

FIGS. 5 and 6 show diagrams of two antenna units for a single sector, according to respective exemplary embodiments of the invention;

FIG. 7 shows a block diagram of a switch unit arrangement of a device, according to an exemplary embodiment of the invention;

FIG. 8 is a block diagram of the procedure for processing the radar signal by a double-frequency CW configuration;

FIG. 9 is a block diagram of the threshold detection step of the processing procedure shown in FIG. 8;

FIG. 10 is a block diagram of a range measurement step;

FIG. 11 is a block diagram of a azimuth angle computation step;

FIGS. 12A-12C are diagrams of three steps of a procedure of tracking a bullet, of backtracking and of localizing a shooter position;

FIG. 13 is a block diagram of a step of tracking and computing a trace, and of localizing the place from which bullet is arriving;

FIG. 14 is a block diagram of a procedure of processing a radar signal by a LFMCW configuration;

FIG. 15 diagrammatically shows the operation of a radar device according to the invention, according to the range-gating technique;

FIG. 16 diagrammatically shows the operation of a radar device according to the invention, comprising an acoustic sensor;

FIG. 17 shows a portable device for localizing small weapons, according to an exemplary embodiment of the invention;

FIG. 18 shows a device according to an exemplary embodiment of the invention, arranged to protect a vehicle.

### DESCRIPTION OF A PREFERRED EXEMPLARY EMBODIMENT

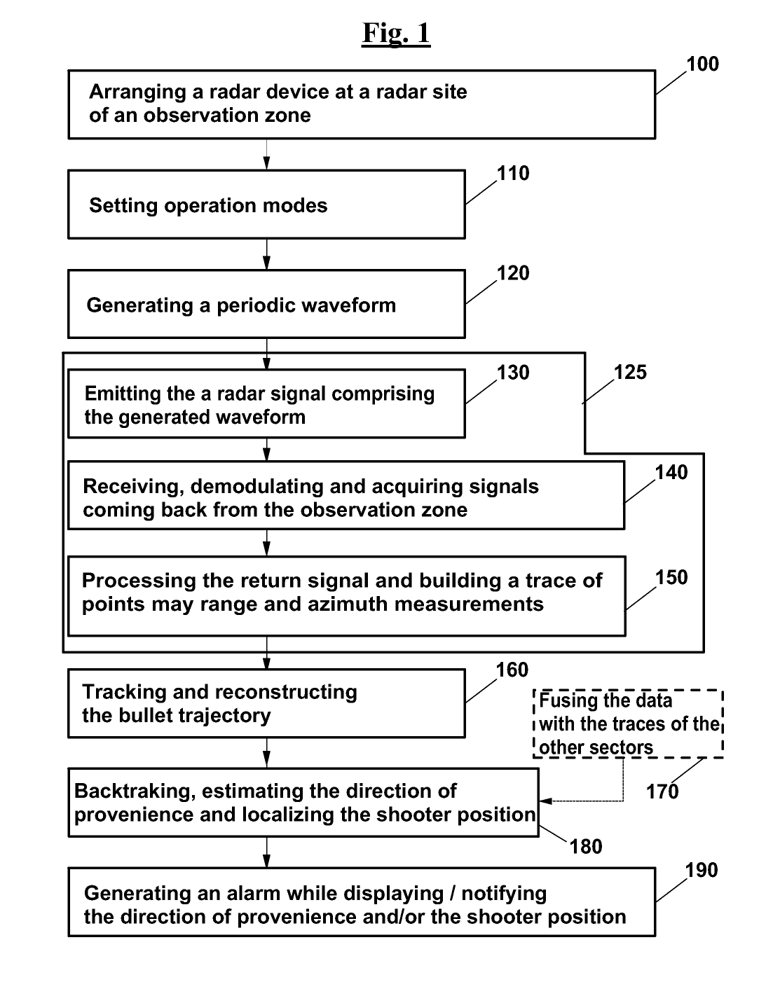

With reference to the block diagram of FIG. 1, a method is described hereinafter for determining the trajectory of a bullet shot by a direct shot small arm weapon, said bullet travelling at a supersonic or at a subsonic speed, by a radar device. A description is also provided of a radar device for carrying out the method according to the invention.

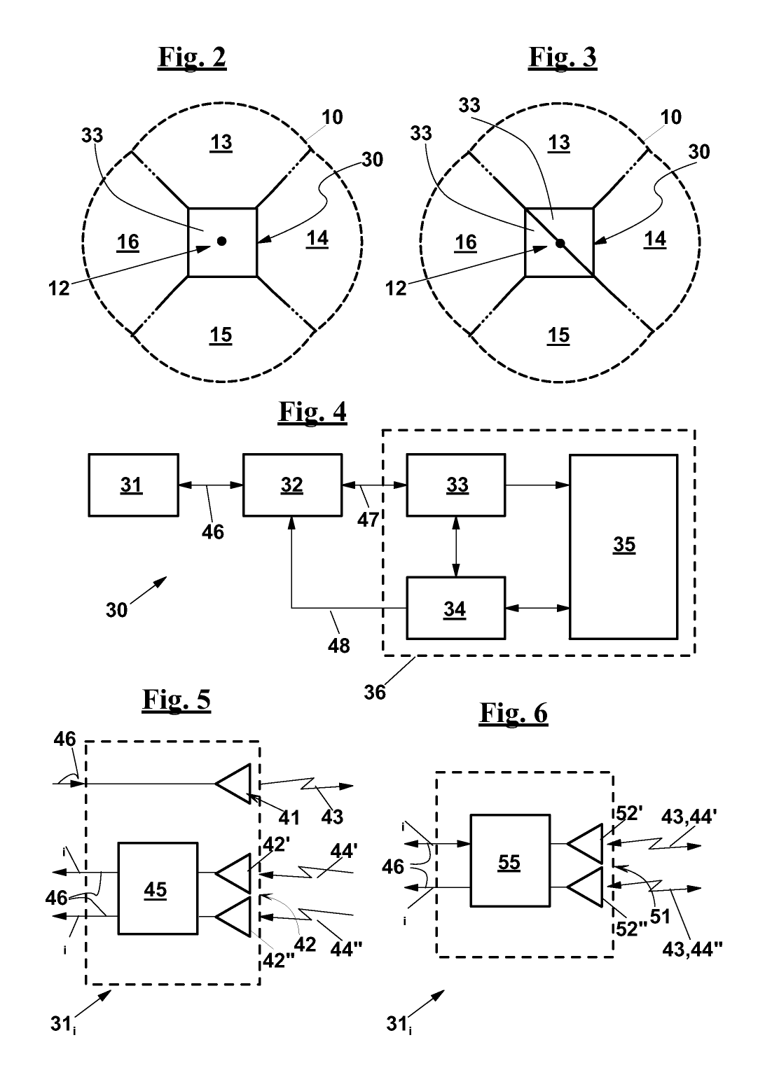

The method comprises a step 100 of arranging a radar device 30 at a radar site 12 of an observation zone 10, as shown in FIGS. 2 and 3. Observation zone 10 is defined by an azimuth angle, in this case a 360° angle, that has a vertex at radar site 12. Observation zone 10 can comprise a plurality of sectors, for example four sectors 13,14,15,16, each defined by a 90° angle that has its vertex at radar site 12.

Sill with reference to FIG. 1, the method comprises a step 110 of setting operation modes of radar device 30. In particular, in the setting step 110, a selection occurs of parameters for carrying out a step 120 of generating a periodic waveform for a radar signal used in a subsequent step 125 of radar-scanning observation zone 10. As well known, radar-scanning step 125 essentially comprises a step 130 of emitting the radar signal, comprising this waveform, and a step 140 of receiving, demodulating and acquiring return signals coming from observation zone 10 in response to the previously transmitted radar signal.

According to the invention, in order to determine the trajectory of a bullet shot by a small arm weapon, said bullet travelling at a supersonic or at a subsonic speed, the radar-scanning step, unlike what is made in DE 2011 012 620 B3, provides a combination of operations comprising a direct determination of a set of points (plots), by directly measuring the range and the azimuth angle of each point, using a very short coherent integration time (TIC), as described hereinafter, which is set between two values, i.e. between a minimum value and a maximum value, depending on the wavelength λ of the signal, and using a very high sampling rate f_{c}, which is higher than a minimum value f_{c,min}, which depends on the radar signal frequency.

This solution makes it possible to determinate the trajectory of the bullet with a higher precision, with respect to the known systems.

In the case of FIG. 2, a single radar transceiver 33 is used, which is configured for time-division scanning each sector 13,14,15,16 into which observation zone 10 is divided.

In the case of FIG. 3, a plurality of radar transceivers 33 is used, in this case two transceivers, each of which is configured for carrying out time-division scanning step 125 on a part or on all sectors 13,14,15,16. More in detail, each transceiver 33 is configured for time-division scanning a respective couple 13,14 or 15,16 of sectors, respectively, each couple of sectors defining an azimuth angle of 180°.

FIG. 4 shows a diagrammatical view of a radar device 30 according to an exemplary embodiment of the invention, comprising an antenna unit 31, an antenna switching unit 32 and a radar unit 36. Radar unit 36 serves for operating and controlling radar device 30. In particular, radar unit 36 sets the operation mode of radar device 30, and actuates each unit and module according to corresponding instructions.

More in detail, radar unit 36 comprises a transceiver unit, i.e. a transceiver 33, a transception control unit 34 for controlling the operation modes, the generation of the waveform and the commutation, and an acquisition, control and processing unit 35, i.e. a drive unit for setting the operation mode and the waveform, and for processing the return signals. In other words, radar unit 36 comprises hardware and software modules for driving the apparatus, for generating the desired waveform, for selecting the predetermined operation mode, for displaying data and alarms and for communicating with the operators.

Transceiver 33 serves for amplifying the radar signal and sending it to antenna unit 31, and also serves for receiving, demodulating, and filtering the return signal coming back from the scenario, for making it fit for acquisition, control and processing unit 35, in particular, for the analog-to-digital conversion means included therein.

For time-division scanning sectors 13,14,15,16, antenna unit 31 comprises a plurality of sector-oriented antennas 31ᵢ, for example of the type shown in FIG. 5 or in FIG. 6, more in detail described hereinafter. Each sector-oriented antenna 31ᵢ is arranged to transceive a radar/back signal sent to/coming from at least one sector selected among sectors 13,14,15,16 into which observation zone 10 is divided. More in detail, antenna unit 31 of device 30 comprises as many sector-oriented antenna modules 41/42, or 51, as the N sectors 13,14,15,16, into which the whole azimuth angle is divided, which are four in the case of FIG. 2, and two in the case of FIG. 3.

Moreover, switching unit 32 is configured for selectively connecting transceiver 33 with at least one sector-oriented antenna 31ᵢ.

For instance, in the configuration of FIG. 2, antenna unit 31 comprises four antenna modules 31ᵢ, and switching unit 32 comprises four channels for switching transceiver 33 to the four sectors. Instead, in the configuration of FIG. 3, radar device 30 comprises two antenna modules 31ᵢ and switching unit 32 comprises only two channels, each intended for switching between two sectors corresponding to sector-oriented antenna 21 or to transceiver 22.

Furthermore, transceiver control unit 34 comprises a program means for operating switching unit 32 according to a radar-scanning programme. The radar-scanning program may comprise a step of discovery, in which transceiver 33 is connected in turn, and for a predetermined time interval, with each sector-oriented antenna of antenna unit 31. In addition, the radar-scanning program can comprise a step of tracking a moving target, wherein transceiver 33 is connected to at least one sector that receives return signals from a given moving target, and a step is provided of switching from the step of discovery to the step of tracking the target, and vice-versa, in case of appearance/disappearance of a moving target, according to conventional radar technique.

The time during which a transceiver 33 remains at a given sector 13,14 and/or 15,16 is called coherent integration time (TIC).

In particular, FIG. 5 shows an exemplary embodiment of one of the antenna modules 31ᵢ of an antenna unit 31, in which two distinct modules 41,42 are provided for emitting a radar signal 43 and for receiving return signals 44′,44″, coming from the corresponding sectors of the radar scenario in response to radar signal 43, respectively. Receiving module 42 comprises two antennas 42′ and 42″ for receiving signals 44′ and 44″, respectively. Antennas 42′ and 42″ are arranged at a known mutual distance, and can be configured, along with radar unit 36, for working in monopulse mode.

Antenna module 31ᵢ can comprise a component such as a hybrid coupler 45 that is functionally connected to antennas 42′,42″ and is configured for distributing incoming return signals 44+,44″ to a couple of RX channels Σᵢ and Δᵢ;

FIG. 6 shows a further exemplary embodiment of one of antenna modules 31ᵢ, as an alternative to the embodiment of FIG. 5, wherein a single element 51 that is configured for both emitting a radar signal 43 and receiving incoming return signals 44′,44″ through antennas 52′,52″. Antenna module 31ᵢ can comprise such a component as a hybrid coupler 55, which is functionally connected to the antennas 52′,52″ and is configured for distributing the incoming return signals 44′,44″ to a couple of RX channels Σᵢ, Δᵢ. The channel Σᵢ of the hybrid coupler 55 is used both in emission and in reception, whereas the channel Δᵢ is used only in reception.

In the exemplary embodiments of FIGS. 5 and 6, channels Σᵢ and Δᵢ form a connection means 46 between antenna unit 31 and antenna switching unit 32 (FIG. 4).

According to the invention, transceiver control unit 34 can be configured for operating with a coherent integration time TIC set between two values, i.e. between a minimum value and a maximum value, which depend on the signal wavelength λ. These minimum and maximum values can be expressed as k₁λ^{1/2} and k₂λ^{1/2}, respectively, wherein, for example, k₁=10 and k₂=40. For instance, in the case of a 9 GHz frequency signal, which corresponds to a λ value of about 0.033 m, the coherent integration time is set between 1.8 and 7.3 ms. Preferably, the coherent integration time is set between 3.7 and 5.4 ms, more preferably between 4.7 and 5.1 ms, in particular, it is about 5 ms. For instance, in another exemplary embodiment, k₁ and k₂ values may be 30 and 35 or 22 and 32, respectively, which correspond to TIC narrower ranges.

According to the invention, radar unit 36 can be configured for carrying out reception step 140 (FIG. 1) at a sampling rate f_{c} higher than a minimum value f_{c, min}, depending on the radar signal frequency. In other words, acquisition, control and processing unit 35 of radar unit 36 comprises an analog-to-digital converter that is configured for sampling one value of the return signal every 1/f_{c} seconds.

In an exemplary embodiment, f_{c,min} is 54 kHz for a signal frequency v of 4 GHz, and is 240 kHz for v equal to 18 GHz. For intermediate frequencies v set between 4 GHz and 18 GHz, minimum value f_{c,min} can be obtained by interpolation of the above-mentioned minimum values for 4 GHz and 18 GHz. For instance, minimum values f_{c,min} at intermediate frequencies can be obtained by a linear interpolation procedure, i.e. through the formula f_{c,min}=(40/3)v, where v is expressed in GHz, and f_{c,min} is expressed in kHz.

With reference to FIG. 7, antenna switching unit 32 (FIG. 4) comprises three switching matrices 60,60′ and 60″ operated by a control module 32′, in order to selectively connecting radar unit 36 (FIG. 4) to one of modules 31ᵢ of antenna unit 31 of one sector 13,14,15,16. Module 31ᵢ to be connected is selected through a plurality of contact members of emission channels TXᵢ and of reception channels Σᵢ and Δᵢ respectively. Control module 32′ has a control connection 48 with transceiver control unit 34 of radar unit 36 (FIG. 4), and is configured for receiving, through control connection 48, a switching control signal that is generated by a program means of control unit 34.

In an exemplary embodiment, step 130 of emitting radar signal 43 is carried out permanently during scanning step 125.

In particular, radar unit 36 is configured for causing transceiver 33 to work with a double-frequency CW waveform. For example, radar signal 43 comprises two continuous sinusoidal tones.

Radar unit 36 performs step 130 of emitting signal 43 that has a waveform advantageously generated after a step of amplifying signal 43. Radar unit 36 performs reception and demodulation steps 140 of return signals 44′,44″, which operation zone 10 returns in response to signal 43 through one of the sector-oriented antennas of antenna unit 31.

Reception and demodulation steps 140 can be carried out according to conventional radar reception and demodulation techniques. In particular, the demodulation step comprises a step of filtering and conditioning the received signal in order to make it fit for the working voltage of an analog-to-digital conversion module 35′ (ADC), according to a conventional technique.

Signal acquisition, control and processing unit 35 (FIG. 4) carries out a step 150 of processing the received signal, thus completing scanning step 125 (FIG. 1), as described more in detail hereinafter.

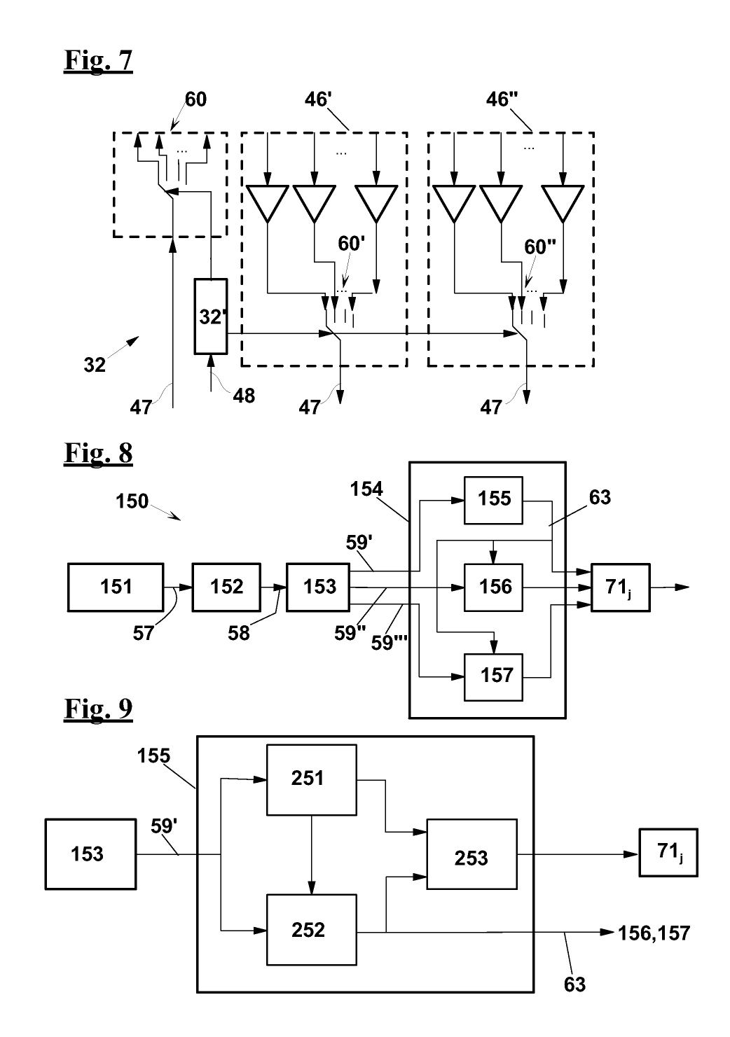

With reference to FIG. 8, step 150 (FIG. 1) of processing the return signals is described in the case of a radar signal 43 that has a continuous double-frequency CW waveform. Processing step 150 comprises a step 151 of filtering away the contributes of fixed targets, i.e. of clutter. Filtering step 151, from which a filtered signal 57 is obtained, serves to damp sudden changes of the signal and to reduce the effects of the clutter on subsequent Doppler filtering steps 152, from which a Doppler filtered signal 58 is obtained, and on a subsequent step 154 of detecting and estimating target parameters such as the distance, i.e. the range, the speed and the angle, which are required for carrying out possible subsequent steps 160 of tracking or reconstructing the bullet trajectory and a backtracking step 180 (FIG. 1). The set of target parameters, i.e. range, azimuth angle, as well as an id of the set itself, is called plot 71ⱼ. In order to detect the targets, in this case the bullets, processing step 150 comprises in fact a Doppler analysis, i.e. a frequency spectrum analysis of return signal 44′,44″ (FIGS. 5 and 6) back from observation zone 10, as it is well known from the radar technique for separating the moving targets from the rest of the scenario.

Doppler filtering steps 152 can be carried out, for instance, by a Fast Fourier Transform (FFT).

In a channels generation step 153, Doppler filtered signal 58, as obtained by Doppler filtering step 152, is distributed to three channels, i.e. to a detection channel 59′, to a monopulse angular measure channel 59″ and to a range channel 59′″.

In the exemplary embodiment of FIG. 8, for each revealed object, Doppler filtered signal 58 is used in a step 154 of generating plot data 71ⱼ. In particular, each plot datum 71ⱼ comprises an id of plot data 71, along with the range and azimuth values of bullet 1. In particular, a plot datum 71ⱼ may comprise a datum selected among a bullet speed value, a signal-to-noise ratio (SNR), and a detection time.

Plot data generation step 154 comprises a threshold detection step 155, a step 156 of monopulse measurement and computing the azimuth angle, and a range computation and calibration step 157. Embodiments of steps 155,156 and 157 are shown more in detail in FIGS. 9, 10 and 11, respectively.

As diagrammatically shown still in FIG. 8, on the Doppler filters by which detection step 155 is carried out, signals acquisition, control and processing unit 35 performs:
a threshold detection step 155 of plot 71ⱼ,
a range computation step 157, i.e. a step of computing the distance of bullet 1 from radar site 12, in particular, by a differential analysis in which the phase values of the two tones received from a same objectare compared, and
an azimuth angle computation step 156 carried out by a monopulse technique, i.e. a step of computing the angular position of bullet 1 with respect to radar site 12.

In the exemplary embodiment of FIG. 9, threshold detection step 155 can be carried by the well-known CFAR (Constant False Alarm Rate) technique. Advantageously, in order to contain the occurrence of false alarms in a given time, the algorithm used in detection step 155 is of an OS-CFAR (Ordered Statistic CFAR) type algorithm. More in detail, threshold detection step 155, which comprises a step 251 of acquiring instant values of signal 58, a step 252 of computing an average value of this signal, and also comprises a step 253 of comparing each instant value with the average value, and of assessing whether the instant value is a plot or not, in which noise instant values are separated from the values that can be recognised as plot values, and a plot id is assigned to the latter.

FIG. 10 diagrammatically shows range computation step 157, starting from Doppler filtered signal 58 received through range channel 59′″. Range computation step 157 comprises a step 271 of computing the phase difference Δφ between the received signals at the two frequencies in use for emitting the signal, a step 272 of computing range R according to the formula R=[(Δφ C)/(4πΔf)], and a step 274 of calibrating the range measurement through a well-known procedure of computing the deviation of the datum, as measured by the radar, from this formula, and of correcting the formula according to the deviations, by means of a calibration table 273. A deviation can be caused, for instance, by non-ideality conditions, internal instability conditions, and the like.

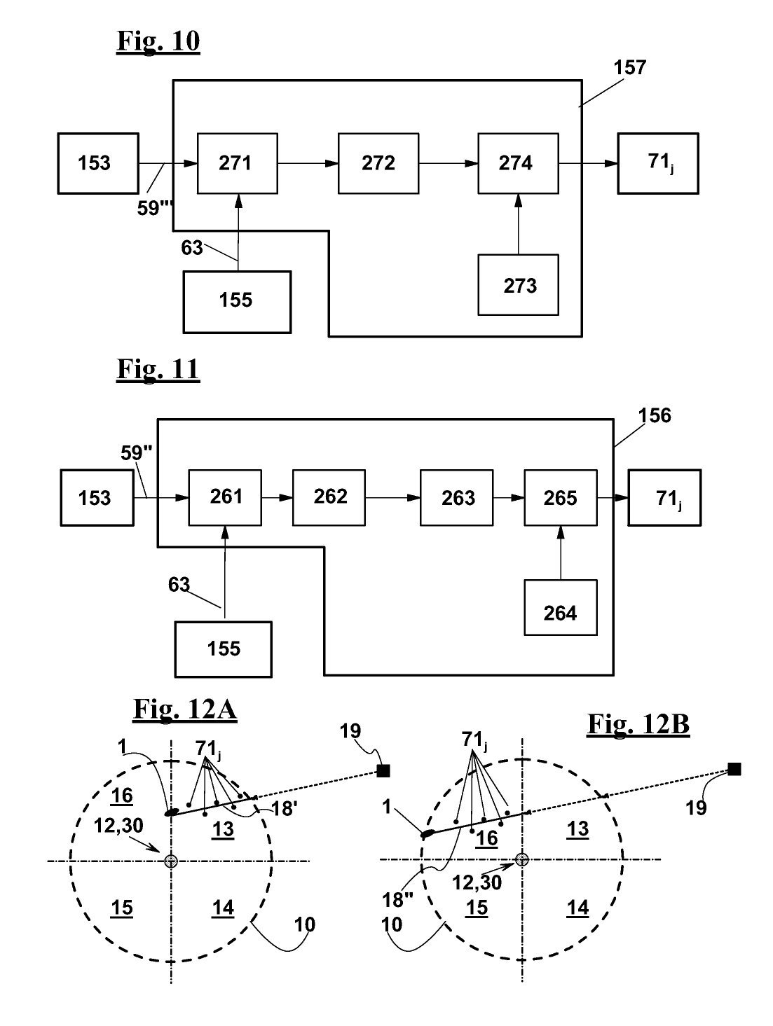

FIG. 11 diagrammatically shows the azimuth angle computation step 156 starting from Doppler filtered signal 58 received through monopulse angular measure channel 59″, comprising a step 261 of computing a monopulse curve by calculating the ratio M=Δ/Σ of the signal provided by channel Δ and the signal provided by channel Σ (FIGS. 5 and 6); a step 262 of computing phase \hat{θ}, according to the formula:

$$\hat{θ} = ℜ \{ \frac{λ}{2 \cdot d} \cdot arc tg ( M ) \} ;$$

a step 263 of computing azimuth angle φ_{AZ} as arcsin(\hat{θ}); and comprising an offset calibration step 265, by means of a calibration table 264.

During threshold detection step 155, a signal 63 is generated that is used in steps 156 and 157 of computing the range and the azimuth angle, respectively, in order to associate only significant calculated range and azimuth values, i.e. the values that correspond to the events revealed as plots at threshold detection step 155, to plot 71ⱼ.

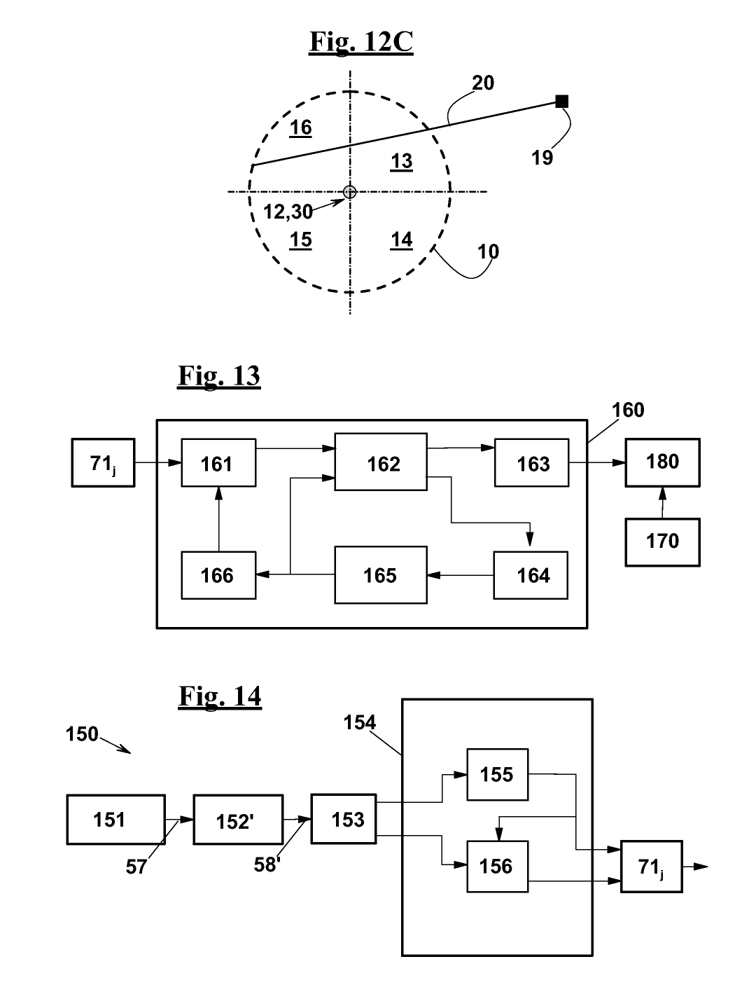

With reference to the sequence diagram of FIGS. 12A-12C, a bullet 1 shot at a shooter position 19 enters observation zone 10 of radar system 30 (FIG. 12A), more precisely it enters the zone corresponding to sector 13, where it travels along trace 18′ and where it is detected and tracked. Afterwards, the bullet leaves sector 13 and reaches sector 16 (FIG. 12B), where it travels along trace 18″ and where it is detected and tracked.

In an exemplary embodiment, when a bullet 1 is revealed, acquisition, control and processing unit 35 of radar unit 36 (FIG. 4) is configured for carrying out step 160 of tracking bullet 1 and of reconstructing a trajectory 20 of bullet 1 starting from detections made in previous consecutive TIC, for example in the same angular sector 13 or 14 or 15 or 16.

By so-called backtracking algorithms, the direction of provenience of bullet 1 and shooter position 19 are determined.

In other words, the algorithms for reconstructing the trajectory use range and azimuth measurements (FIGS. 10 and 11) in a polar reference system, transform the trajectory into a Cartesian reference and then carry out the fitting of trajectory 18′,18″. To this purpose, as described, the Doppler analysis can be exploited, thus obtaining a mixed algorithm, which uses both the range and angle measurements and the Doppler measurements of the radial speed, which is substantially a derivative of the range. The algorithm is based on well-known optimum estimate and recursive digital filtering techniques.

FIG. 13 shows a block diagram of step 160 of tracking and computing bullet trajectory 18′,18″ (FIG. 1), up to step 180 of localizing shooter position 19 (FIGS. 12A-12C), according to an exemplary embodiment of the invention. Step 160 of tracking and computing the trajectory can be represented as the operation of a state machine that receives plot data 71ⱼ at each state and returns the already closed trajectories 18′,18″. In other words, on the basis of plot 71ⱼ, a step 161,162,164 of reconstructing traces 18′,18″ is carried out, when a shot is fired, as well as a step 163 of reconstructing or computing a line 20 that can be assimilated to the trajectory of bullet 1, starting from traces 18′,18″.

More in detail, tracking step 160 includes:
a step 161 of associating a plurality of plot data of points 71ⱼ to a same trace or to a same hypothesis of trace, and a trace managing step 162. Trace managing step 162 comprises in turn:
a step of updating a list of hypothesis of trace. Moreover, trace managing step 162 comprises a plurality of decision steps based on the content of the traces of the list. In particular, trace managing step 162 comprises a step of
transforming the hypothesis of traces including an adequate number of plots into traces, and steps of:
closing and displaying traces 18′,18″ (FIGS. 12A, 12B) as completed traces, i.e. as traces of targets that have already left observation zone 10 (FIGS. 2 and 3). Displayed traces 18′,18″ can be used in a
step 163 of reconstructing of trajectory 20 of bullet 1 (FIG. 12C).
   Moreover, trace managing step 162 comprises further decision steps, such as steps of:
cancelling hypothesis of trace that have not been confirmed by an adequate number of plots 71ⱼ from the list of the hypothesis of trace;
confirming hypothesis of trace in the list of the hypothesis of trace, updating the latter according to plot data 71ⱼ associated to the hypothesis of trace and memorizing the status of the algorithm;
creating new hypothesis of trace starting from plots that are not associated with any trace.

On this basis, a trace updating step 164 is provided, in which the parameters of each trace/hypothesis of trace are changed in the light of the plot associated to it, or considering that no plot has been associated with the trace/hypothesis of trace. This step is a requirement for a
step 165 of defining and updating a status that comprises a plurality of traces and/or of hypothesis of trace. Each trace/hypothesis of trace contains the following data:
   a list of plots 71ⱼ;
   a foreseen status of bullet 1;
   a score of the hypothesis.
      Status 165 is the object of trace managing step 162.

Starting from each trace/hypothesis of trace, it is possible to extract, by a
prediction step 166, a forecast of a future position of bullet 1, in terms of range, speed and angle. At most, a plot can be associated with a single trace/hypothesis of trace, and vice-versa.

In a subsequent data-fusion step 170 (FIG. 1), traces 18′,18″ corresponding to sectors 13 and 16, respectively, are fused with each other, and trajectory 20 of bullet 1 is reconstructed (FIG. 12C). This occurs, for instance, in trajectory reconstruction step 163, as shown in FIG. 13.

The reconstruction of the line can be carried out also by a technique of computing a motion law of bullet 1, on the basis of the data obtained from step 154 of generating plot 71ⱼ.

Acquisition, control and processing unit 35 (FIG. 4) can also be configured for carrying out step 180 of backtracking and of determining the direction of provenience of bullet 1, and of localizing shooter position 19 (FIG. 12C). Backtracking step 180 may comprise step 170 of fusing traces 18′,18″ that relate to different sectors of observation zone 10.

In another exemplary embodiment, transceiver 33 comprises radar unit 36 configured to generate an LFMCW continuous waveform. In other words, radar unit 36 is configured to generate a linearly frequency-modulated waveform.

With reference to FIG. 14, a possible step 150 is described (FIG. 1) of processing the return signals in the case of a radar signal 43 comprising an LFMCW waveform (linearly frequency-modulated continuous wave). In an exemplary embodiment, radar unit 36 is configured for carrying out a range-Doppler filtering step that is suitable for calculating the range and the radial speed of an object at the same time. Radar unit 36 is configured for determining, after the detection, the azimuth angle of the object by a monopulse technique. In other words, processing step 150 differs from the corresponding step of processing the double-frequency radar signal of FIG. 8 in that it comprises an adapted range-Doppler filtering step 152′ specifically conceived for waveform LFMCW. Adapted range-Doppler filtering step 152′ makes it possible to calculate the range, i.e. the distance between radar site 12 and bullet 1, before carrying out threshold detection step 155.

On the other hand, threshold detection step 155, for example a threshold detection step that uses the CFAR technique and monopulse measuring and computation step 156 can be carried out as they are carried out in the case of a radar signal comprising a double-frequency CW waveform, according to the description of FIGS. 9 and 11. Threshold detection steps 155 and angle monopulse measuring and computation step 156 complete step 154 of generating plot data 71ⱼ.

Also trajectory tracking and computing step 160, and step 180 of backtracking and localizing shooter position 19, may be carried out as they are in the case of a radar signal comprising a double-frequency CW waveform, according to the description of FIG. 13.

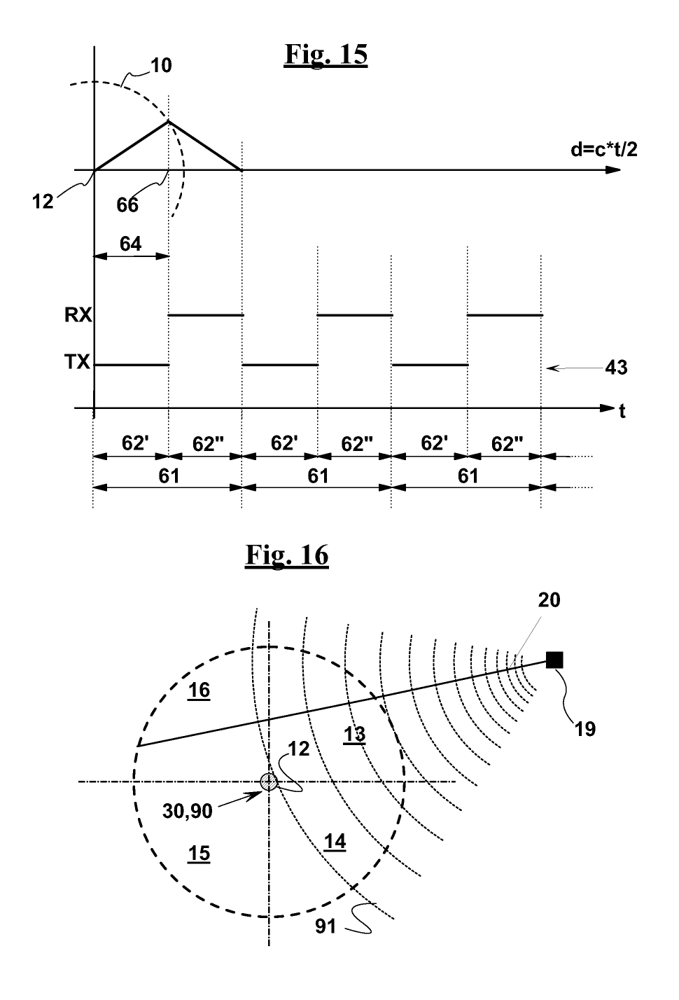

With reference to FIG. 15, in an exemplary embodiment, the radar system or systems 30 comprise/s a radar unit 36 (FIG. 4) that is configured for generating a periodic waveform 43 according to the range-gating technique. In other words, a radar signal 43 (FIGS. 5,6) is emitted during an emission step, i.e. during an operation step of emission means TX of antenna unit 31 (FIG. 4) during a emission time interval 62′. Afterwards, radar unit 36 turns off emission means TX of antenna unit 31 (FIG. 4). The emission step is repeated with a frequency i.e. at a rate that has a cycle duration 61 longer than emission time interval 62′.

After turning off the emission means, radar unit 36 turns on reception means RX of antenna unit 31. Reception means RX remains active during a reception time interval 62″, during which the reception step is carried out, and during which emission means TX are inactive.

This way, the signals coming from the nearest zones, i.e. from zones that have the shortest range, are attenuated more than the signals coming from the farthest zones, i.e. from zones that have the longest range.

In particular, if duration 62′ of the emission step and duration 62″ of the reception step are equal to each other, as In the case of FIG. 15, the attenuation decreases linearly down to a minimum value at instant t₁, i.e. once a time interval has elapsed equal to duration 62′ of the emission step since when emission means of antenna unit 31 was turned on. Afterwards, the attenuation increases linearly up to a maximum value once a time interval has elapsed equal to 62′+62″.

As shown still in FIG. 15, the duration of cycle 61, and emission time interval 62′ are selected so that the attenuation, i.e. the local sensitivity decrease, has a minimum value at a maximum observation distance 64, selected for example as a distance of about 100 m.

Besides separating the emission instant from the reception instant and limiting the effects of the coupling between emission means TX and reception means RX, range-gated signal 43 makes it possible to reduce any noise arising close to the radar device. For instance, this noise can be an electrostatic noise, such as the noise due to rain drops falling to the ground, or to metal or electrostatically charged objects coming occasionally into contact with each other. By the range-gating technique, the saturation and the subsequent sensitivity loss of the receiver due to local noise can be prevented.

In summary, at a short distance, the attenuation or sensitivity decrease of the contribution of the approaching bullet can be tolerated, while the contribution of the local electrostatic noise is substantially eliminated.

In particular, reception duration 62″, during which only reception means RX of antenna unit 31 are active, is complementary of emission time interval 62′ with respect to the overall duration of cycle 61, in other words, reception means RX is turned on immediately after emission means TX of antenna unit 31 are turned off.

As an alternative, once emission time interval 62′ has elapsed in each cycle, i.e. once emission means TX have been turned off, and before turning on reception means RX of antenna unit 31, a separation time interval, not shown, can be awaited, during which both emission means TX and reception means RX are inactive. A separation time interval of a few nanoseconds makes it possible to further reduce the local noise and to eliminate the unwanted coupling of emission means TX and reception means RX, further dumping sudden changes with respect to the mode CW. As well known, by awaiting a separation time interval before turning on the reception means, a blind zone is created about radar site 12, from which no return signal is received. However, the extension of this blind zone, with a separation time interval as indicated above, is very small, with respect to the safety distance at which the bullets are detected effectively so that an operator can protect himself and/or react. For instance, with a separation time interval of 20 nanoseconds, the extension of the blind zone is about 3 metres, which is a distance much shorter than the safety distance at which a bullet should be detected.

Signal processing step 150, up to extraction 154 of plot data 71ⱼ (FIGS. 8,14), bullet tracking and trajectory computing step 160 (FIG. 13), data fusion step 170 of traces in distinct sectors, and step 180 of backtracking, calculating the direction of provenience and localizing shooter position 19, can be carried out as described for devices in which radar unit 36 is configured for permanently emitting a periodic CW or LFMCW signal (FIGS. 8-14).

Still with reference to the block diagram of FIG. 1, step 180 of localizing shooter position 19 is advantageously followed by a step 190 of generating an alarm that can comprise displaying or notifying the direction of provenience of bullet 1 and displaying or notifying shooter position 19.

FIG. 16 shows an exemplary embodiment of the device according to the invention, in which radar device 30 comprises an acoustic sensor 90. Acoustic sensor 90 is configured for detecting an incoming compression wave 91 generated by a shot. In this case, backtracking step 180 of bullet 1 (FIG. 1) is stopped as soon as the acoustic sensor arranged immediately close to the radar antenna, detects compression wave 91. This allows more accurately localizing shooter position 19.

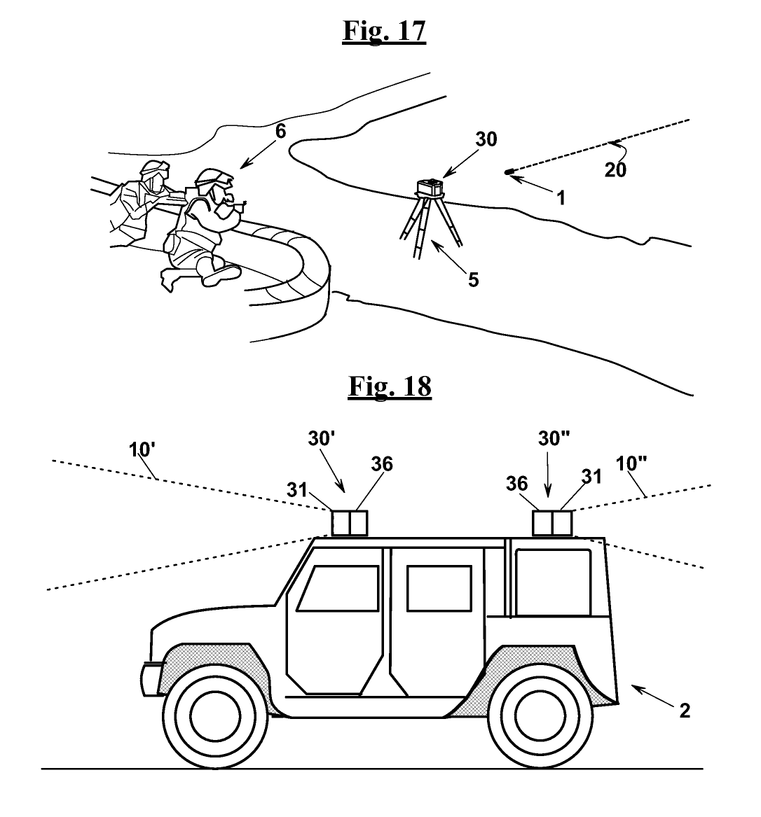

FIG. 17 shows a portable radar equipment 30, according to an exemplary embodiment of the invention, for determining the trajectory of a bullet 1 fired by a small firearm. Portable equipment 30 can be used to protect a movable position such as a checkpoint, an outpost and the like, and is configured to be mounted on a trestle 5. By equipment 30, operators 6 can estimate the direction of provenience of bullet 1 and possibly even the coordinates of the shooter position, not shown. This makes it possible to take countermeasures.

In an exemplary embodiment, the portable equipment can be used for protecting a vehicle 2, as shown in FIG. 18. In this case, the equipment advantageously comprises an interface with an inertial system, not shown, in order to restore the correct geographic reference or any position reference of the vehicle. This way, it is possible to determine the trajectory of bullets and possibly to localize the absolute shooter position, even if a sudden position change of vehicle 2 or a high acceleration condition occurs, which is the case when vehicle 2 travels, in particular, on an irregular ground. In the exemplary embodiment of FIG. 18, the equipment comprises two radar devices 30′,30″, to be arranged at a front portion or at a rear portion of the vehicle, each radar device comprising a radar unit 36 and an antenna unit 31 as described above, in which the antenna is configured for inspecting two observation zones 10′,10″ before and behind the vehicle.

The above description relates to one of the possible embodiments of the present invention. Other embodiments can differ from what is described, even if they fall within the scope of invention, in some specific aspects such as the waveform, the way the signal is processed, the decision logic means, the way different detection system are integrated, in order to improve the localizaion of the shooter position and the like.

The description as above, of exemplary specific embodiments will so fully reveal the invention according to the conceptual point of view, so that others, by applying current knowledge, will be able to modify and/or adapt for various applications such embodiments without further research and without parting from the invention, and, accordingly, it is to be understood that such adaptations and modifications will have to be considered as equivalent to the specific embodiments. The means and the materials to realise the different functions described herein could have a different nature without, for this reason, departing from the scope of the invention. It is meant that the phraseology or terminology that is employed herein is for the purpose of description and not of limitation.

### REFERENCE

1) Allen M. R. et al., in “A low-cost radar concept for bullet direction finding”, from the acta of the 1996 IEEE national radar conference, held at the Michigan University, Ann Arbor, Mich. May 13-16, 1996, IEEE New York, USA May 13, 1996, pages 20-207.

1. A method for determining a trajectory (20) of a bullet (1) shot by a firearm, said method comprising the steps of:
defining an observation zone (10);
defining a radar site (12);
arranging (100) an electronic-scan radar device (30) at said radar site (12);
scanning (125) said observation zone (10) by said radar device (30), wherein said step of scanning (125) comprises the steps of:
emitting (130) a radar signal (43) comprising a periodic waveform that has a frequency (v) set between 4 GHz and 18 GHz;
receiving and demodulating (140) a return signal (44′,44″) returned from said observation zone (10) in response to said radar signal (43);
wherein said step of scanning (125) also comprises a step of:
processing (150) said return signal (44′,44″) and reconstructing (161,162,164) a trajectory (20) of said bullet (1),
wherein said step of radar-scanning (125) has a coherent integration time (TIC), for a predetermined wavelength λ of said signal, set between 10λ^{1/2} and 40λ^{1/2}, wherein said wavelength λ is expressed in metres and said coherent integration time is expressed in milliseconds,
wherein said step of processing (150) said return signal comprises a step of sampling said return signal (44′,44″) at a sampling rate (f_{c}) higher than a predetermined lower limit value f_{c,min} depending on said frequency (v) of said radar signal (43),
said step of reconstructing (161,162,164) comprising, for each revealed bullet (1), steps of directly measuring points or plots (71ⱼ) of a radar trace (18′,18″) of said bullet (1), said steps of measuring comprising, for each of said plots (71ⱼ), steps of:
measuring (156) a range of said bullet (1), i.e. a distance of said bullet (1) from said radar site (12);
measuring (157) an azimuth angle of said bullet (1) with respect to said radar site (12),
and wherein a step is provided of computing (163), starting from said trace (18′,18″), a line (20) passing proximate to said plots (71ⱼ), wherein said line is assumed as said trajectory (20) of said bullet (1).

2. The method according to claim 1, wherein said radar signal (43) is a continuous-wave (CW) radar signal.

3. The method according to claim 2, wherein said continuous-wave (CW) radar signal (43) comprises two waveforms that have respective distinct frequencies, in particular said radar signal (43) comprises two sinusoidal tones that have respective distinct frequencies.

4. The method according to claim 1, wherein said radar signal (43) comprises a linearly frequency-modulated continuous waveform (LFMCW).

5. The method according to claim 1, wherein said lower limit value f_{c,min} is defined by the formula:
f_{c,min}=(40/3)v,
wherein v is the frequency of said radar signal (43) expressed in GHz, and f_{c,min} is expressed in kHz.

6. The method according to claim 1, wherein a plurality of observation sectors (13,14,15,16) is defined in said observation zone (10), said sectors (13,14,15,16) having a common vertex at said radar site (12), and said step of computing (163) a line (20) comprises a step (170) of fusing traces (18′,18″) detected in sectors (13,16) of said observation sectors (13,14,15,16) that are distinct from one another.

7. The method according to claim 1, wherein said radar signal is a range-gated signal (43), wherein said step of emitting said radar signal (43) is carried out during a predetermined emission time interval (62′) and with a cadence (61) longer than said emission time interval (62′), in order to cause an attenuation of said return signal (44′,44″), wherein said cadence (61) and said emission time interval (62′) are selected in such a way that said observation zone (10) is generated centred at said radar site (12) and is defined by a predetermined maximum observation distance (64), said attenuation having a minimum value at said maximum observation distance (64).

8. The method according to claim 7, wherein a step is provided of waiting a separation time interval after said emission time interval (62′) of said step of emitting (130) and before said step of receiving and demodulating (140).

9. The method according to claim 8, wherein said separation time interval lasts between 10 and 30 nanoseconds, in particular said separation time interval lasts about 20 nanoseconds.

10. The method according to claim 1, wherein said coherent integration time (TIC), for a determined wavelength λ of said radar signal (43), is set between 20λ^{1/2} and 35λ1/2, in particular said coherent integration time (TIC) is set between 22λ^{1/2} and 32λ^{1/2}.

11. The method according to claim 1, wherein said step of processing (150) comprises, for each point (71ⱼ), a step of determining (155) a radial speed of said bullet (1).

12. The method according to claim 1, wherein said step of processing (150) comprises, for each point (71ⱼ), a step of determining (155) an elevation angle of said bullet (1).

13. The method according to claim 12, wherein, a step is provided (180) of localizing a shooter position (19) at a point of said trajectory (20).

14. An electronic-scan radar device (30) for determining, from a radar site (12), a trajectory (20) of a bullet (1) shot from an unknown shooter position, said bullet crossing an observation zone (10) arranged to be observed from said radar device, said radar device (30) comprising:
a radar scan means for carrying out a radar-scanning of said observation zone (10), said radar scan means comprising:
an emission means (31,41,52′,52″) configured for emitting a radar signal (43) comprising a periodic waveform having a frequency (v) set between 4 GHz and 18 GHz;
a reception (31,42) and demodulation (33) means for demodulating a return signal (44′,44″) returned from said observation zone (10) in response to said radar signal (43);
characterized in that said radar scan means comprises:
a signal processing means (35) for processing said return signal (44′,44″) and a detection means (35) for reconstructing a radar trace (18′,18″) of said bullet (1),
wherein said signal processing means (35) and said detection means (35) are configured for operating at a coherent integration time (TIC), wherein, for a predetermined wavelength λ of said radar signal (43), said coherent integration time is set between 10λ^{1/2} and 40λ^{1/2}, wherein said wavelength λ is expressed in metres and said coherent integration time is expressed in milliseconds,
wherein said signal processing means (35) has a sampling rate (f_{c}) of said return signal higher than a predetermined lower limit value f_{c,min} depending on said frequency (v) of said radar signal (43),
wherein said signal processing means (35) is configured for carrying out a direct measurement of parameters of each of said points (71ₖ), said direct measurement comprising:
measuring (156) a range of said bullet (1), i.e. a distance of said bullet (1) from said radar site (12);
measuring (157) an azimuth angle of said bullet (1) with respect to said radar site (12),
and wherein said signal processing means (35) is configured for calculating (163), starting from said trace (18′,18″), a line (20) passing proximate to said plots (71ⱼ), so that said line is assumed as said trajectory (20) of said bullet (1).

15. The radar device (30) according to claim 14, wherein said lower limit value f_{c,min} is defined by the formula:
f_{c,min}=(40/3)v,
where v is the frequency of said radar signal (43) expressed in GHz, and f_{c,min} is expressed in kHz.

16. The radar device (30) according to claim 14, wherein said signal processing means (35) is configured for carrying out a step of backtracking and of localizing a shooter position (19) at a point of said trajectory (20).

17. The radar device (30) according to claim 14, comprising an acoustic sensor (90) configured for detecting a compression wave (91) caused by said shot and travelling towards said radar site (12), wherein said radar device (30) is configured for stopping a step of localizing (180) a shooter position (19) as soon as said compression wave (91) is detected by said acoustic sensor (90).
